(19) United States
(12) Patent Application Publication
(10) Pub. No.: US 2025/0296308 A1
(43) Pub. Date: Sep. 25, 2025

(54) LAMINATED COMPOSITE MATERIAL AND MANUFACTURING METHOD THEREOF

(71) Applicant: YCLOS S.R.L., Pescara (PE) (IT)

(72) Inventors: Anna Maria Di Rienzo, Pescara (PE) (IT); Loreto Di Rienzo, Pescara (PE) (IT)

(21) Appl. No.: 18/863,327

(22) PCT Filed: May 5, 2023
(86) PCT No.: PCT/IB2023/054696

§ 371 Date: Nov. 5, 2024

(30) Foreign Application Priority Data
May 5, 2022 (IT) 102022000009260

(51) Int. Cl. B32B 27/12; B32B 5/02; B32B 7/12; B32B 27/36

(52) U.S. Cl. CPC B32B 27/12; B32B 5/024; B32B 27/36; B32B 7/12; B32B 2262/0276; B32B 2307/7265; B32B 2437/00

(57) ABSTRACT

The present invention refers to a laminated composite material and the manufacturing process thereof. The aforesaid laminated composite material comprises: —an intermediate layer comprising a polymeric monolithic membrane comprising a polyester, said intermediate layer having a first and a second face; —a first outer layer comprising a polyester fabric, said first outer layer having a first inner surface adhering to said first face of said intermediate layer; —a second outer layer comprising a polyester fabric, said second outer layer having a second inner surface adhering to said second face of said intermediate layer. The laminated composite material is suitable for manufacturing protective clothings, in particular protective clothings for medical and surgical use.

### FIELD OF THE INVENTION

The present invention relates to a laminated composite material suitable for manufacturing protective clothings, in particular protective clothings for medical and surgical use.

### BACKGROUND OF THE INVENTION

As is known, the protective clothings used in the medical and surgical field (e.g. gowns and drapes) mainly have the function of minimizing the spread of pathogens from the person wearing them (e.g. a patient or medical personnel) towards the surrounding environment and vice versa. To this end, the protective clothings must first of all be substantially impermeable to the liquids, in particular to the biological fluids, such as blood and urine. If these fluids permeate through the clothings, in fact, they can come into contact with the wearer's skin, favouring contamination by pathogens that may possibly be present in them.

A second requirement that the protective clothings must meet is to be comfortable to wear. In particular, the protective clothings must be breathable, that is, they must allow the passage of the water vapour produced by the perspiration of the skin from the inside of the clothing to the outside, so as to guarantee the natural cooling of the body. In addition, in order to be comfortable, the protective clothings must also have a certain level of drapeability, so as to guarantee sufficient freedom of movement to the wearer.

The protective clothings for medical and surgical use may be disposable or reusable. The disposable clothings are generally made of non-woven fabric in combination with additional performance-enhancing materials. The additional materials may be applied in the form of a coating, for example by finishing the non-woven fabric with fluid-repellent fluorinated substances, or by application of polyethylene or polypropylene film onto the non-woven fabric.

Although the disposable clothings are in many cases preferred due to the low cost of production and the fact that they allow avoiding the necessary reconditioning treatments for reusable clothings, the need to use reusable protective clothings is nevertheless increasingly felt in order to reduce the amount of waste introduced into the environment and the related disposal costs.

In order to be reused, the protective clothings must be manufactured with materials that can withstand repeated sterilization cycles and, therefore, heat treatments (up to temperatures of 130-140° C.) and washing with detergents and disinfectants. Generally, the reusable protective clothings are made with polyester fabrics on which a fluid-repellent coating is applied or with multilayer laminated composite materials comprising microperforated or monolithic membranes in polymeric material (e.g. polytetrafluoroethylene (PTFE), polyurethane or polyester) generally in association with layers of fibrous material, especially layers of non-woven fabric.

Laminated composite materials for the manufacture of disposable or reusable protective clothings are described, for example, in patents US 2019/0366697 A1, US 2011/0039468 A1, US 2002/0106959 A1, US 2004/0121678 A1 and CN 112107041 A.

The laminated composite materials of the prior art, although suitable for the manufacture of protective clothings for medical and surgical use, nevertheless present several drawbacks.

For example, the materials comprising layers of non-woven fabric are reusable only if they are sterilized with particular and expensive dry and low temperature treatment techniques (e.g. ethylene oxide treatments), as the non-woven fabric is a thermolabile material, which readily degrades when subjected to hot or wet washing or sterilization treatments (e.g. steam sterilization, high temperature water washing).

US 2004/0121678 A1, for example, describes a liquid-and pathogen-impermeable laminated material and having antistatic properties, which is usable for the manufacture of protective clothings. In one embodiment, the material comprises a monolithic polyester-based membrane coupled on both faces to a fibrous layer serving as a support. The fibrous layer may be a non-woven fabric, a knitted fabric, an orthogonal fabric. The material forming the fibrous layer can be chosen from numerous types of material, such as polyester, cellulose, nylon, polypropylene, polyethylene and combinations thereof. The laminate has stability such that it can be subjected to sterilization by gamma rays or with ethylene oxide, while its suitability for reuse following repeated washings with or steam water sterilization is not described.

U.S. Pat. No. 5,445,874 describes a laminate for the manufacture of protective clothings comprising an intermediate layer of a monolithic membrane which is coupled on both faces to respective layers of fabric or non-woven fabric, which can be made using materials such as polyester, nylon and polypropylene.

The materials comprising PTFE membranes or coatings with fluid-repellent compositions have instead high production and reconditioning costs (i.e. restoration of the initial performance after use) and also limited recycling possibilities due to the presence of fluorinated substances.

In some cases, moreover, the protective clothings of the prior art, such as operating theatre gowns, include portions of clothing (e.g. sleeves, front, back) that are made with different materials, chosen based on the specific level of exposure of each portion to the pathogens. The presence of several different materials in the same clothing obviously makes the clothings more difficult to recondition and recycle.

### SUMMARY OF THE INVENTION

In view of the aforesaid state of the art, the Applicant has dealt with the problem of providing a textile material, in particular a laminated composite material, for making protective clothings, which overcomes the drawbacks of the prior art.

In particular, the Applicant has set himself the objective of providing a laminated composite material suitable for manufacturing protective clothings for medical and surgical use which, in addition to carrying out an effective barrier action to pathogens, is comfortable for wearer (i.e. breathable and drapeable) as well as easily reusable following repeated hot and wet washing and/or sterilization cycles.

A further objective is to provide a laminated composite material that at the end of its life cycle is easily and substantially completely recyclable; preferably, the recycled material must be able to be reused in order to produce new yarns and textile materials.

The Applicant has now found that the above and other objects, which will be better illustrated in the following description, can be achieved by means of a multilayer laminated composite material, wherein a monolithic polymeric membrane based on polyester is interposed between two outer layers of fabric also based on polyester.

The monolithic polymeric membrane guarantees the substantial impermeability of the laminated composite material to the liquids and therefore to the pathogens. The outer layers of fabric, which are in direct contact with the opposite faces of the polymeric monolithic membrane, give the material adequate mechanical characteristics as well as resistance to repeated sterilization and washing cycles, even in wet and hot mode, thus making the laminated composite material and the products made with it easily reusable several times.

Furthermore, since the material of the layers of the laminated composite material consists predominantly, substantially or exclusively of polyester, the laminated composite material is readily recyclable at the end of its life by means of the recycling methods known in the art for the recovery of polyester from scarp or waste materials containing it. In particular, in the case where the and intermediate layers are formed, outer respectively, by fabrics made exclusively with polyester yarns and monolithic membranes containing only polyester polymers, the recycled material that is obtained is a high purity polyester and therefore suitable to be processed again to produce yarns and/or other valuable products.

The present invention is therefore the result of the searches carried out by the Applicant in order to develop a composite material having the required performance for the protective clothings for medical and materials surgical use, using having a chemical composition as homogeneous as possible and based on polyester polymers, so as to maximize the recycling potentials of the composite material at the end of the life cycle, especially increasing the yield of the recycling process of the polymeric material and the purity of the recycled polyester obtained.

Thus, according to a first aspect, the present invention concerns a laminated composite material comprising:
an intermediate layer comprising a polymeric monolithic membrane polyester, comprising said intermediate layer having a first and a second face;
a first outer layer comprising a polyester fabric, said first outer layer having a first inner surface adhering to said first face of said intermediate layer;
a second outer layer comprising a polyester fabric, said second outer layer having a second inner surface adhering to said second face of said intermediate layer.

In accordance with a second aspect, the present invention concerns an article for preventing or reducing the risk of contamination by pathogens comprising the aforesaid laminated composite material.

In accordance with a third aspect, the present invention concerns a protective clothing comprising the aforesaid laminated composite material.

In accordance with a fourth aspect, the present invention concerns a method for manufacturing the aforesaid laminated composite material comprising the steps of:
a. providing:
   (i). an intermediate layer comprising a polymeric monolithic membrane comprising polyester, said intermediate layer having a first and a second face;
   (ii) a first outer layer comprising a polyester fabric, said first outer layer having a first inner surface;
   (iii) a second outer layer comprising a polyester fabric, said second outer layer having a second inner surface;
b. adhering said first and second inner surfaces of said first and second outer layers respectively to said first and second faces of said intermediate layer to form said laminated composite material.

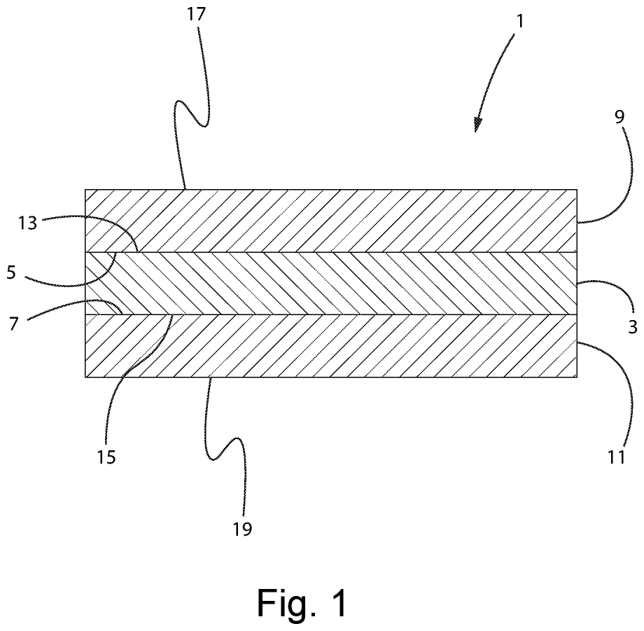

Further characteristics and advantages of the present invention will become apparent from the following detailed description of the invention in which reference will also be made to the attached FIG. 1 which is a schematic cross-sectional representation of the laminated composite material according to the present invention.

For the purposes of this description and of the appended claims, the materials and the compositions according to the present invention may “comprise”, “consist of” or “consist essentially of” essential and optional components described in this description and in the appended claims. For the purposes of the present description and of the appended claims, the term “consist essentially of” indicates that the composition or the component may include additional ingredients, but only to the extent that the additional ingredients do not materially alter the essential characteristics of the composition or of the component.

When a parameter, for example the concentration of a component or a chemical-physical characteristic of a material (e.g. breathability of the monolithic membrane, the count of a yarn, the weight of a fabric, etc.), is expressed by minimum and maximum preferred values, it is understood that for this parameter any range deriving from a combination of any minimum value and any maximum value is described.

For the purposes of this description and of the appended claims, unless otherwise specified, the term “polymer” indicates a homopolymer or a copolymer and the term “polyester” indicates a homopolymer polyester or a copolymer polyester (co-polyester).

With reference to FIG. 1, the laminated composite material 1 according to the present invention comprises an intermediate layer 3 comprising a polymeric monolithic membrane comprising a polyester, wherein the layer has a first face 5 and a second face 7 opposite each other.

The intermediate layer 3 is interposed between a first outer layer 9 and a second outer layer 11, wherein each of the aforesaid outer layers 9 and 11 comprises a fabric of polyester fibres. The outer layers 9 and 11 have respective inner surfaces 13 and 15 and outer surfaces 17 and 19. The inner surfaces 13 and 15 adhere respectively to the aforesaid first face 5 and second face 7 of the intermediate layer 3. The respective outer surfaces 17 and 19 of the outer layers 9 and 11 are intended to face the external environment and/or in contact with the skin of the person wearing the protective clothing.

For purposes of the present disclosure and of the appended claims, the term “monolithic membrane” indicates a non-porous film that is substantially impermeable to the liquids and to the particulate solid material, but permeable to the water vapour and to the air. The monolithic membrane is not a membrane micro-perforated by physical processes. The monolithic membrane instead has passages having a cross-section of such a magnitude as to allow the spread of the molecules of water (or other liquid) inside the membrane, the aforesaid passages being obtained through the polymerization process of the polymeric material of the membrane. The transit of water vapour through the membrane then takes place according to a so-called pervaporation process, which depends on the concentration gradient of the liquid between the two sides of the membrane. The ease of the water vapour crossing the membrane is an indication of the membrane. breathability of the In the present description, the breathability of the monolithic membrane and of the laminated composite material comprising it is expressed as evaporative resistance to water vapour “Rₑₜ” (Water Vapour Resistance) determined according to the method UNI EN ISO 11092:2014 and is expressed in the unit of measurement m²Pa/W.

In accordance with the present invention, the monolithic membrane is a polymeric membrane comprising or consisting of polyester. Preferably, the polyester is a thermoplastic polyester.

Non-limiting examples of polyester polymers usable for the purposes of the present invention are: polyethylene terephthalate, polybutylene terephthalate, polytetramethylene terephthalate, poly-1,4-cyclohexylene-dimethylene terephthalate.

Preferably, the polyester is a copolymer, more preferably a block copolymer.

In a preferred embodiment, the polyester is a block copolymer chosen from: ether-ester block copolymer, imide-ester block copolymer, ether-imide-ester block copolymer and mixtures thereof.

The polymeric chains of the block co-polyesters are formed by “soft” segments and “stiff” segments and are therefore more elastic than the homopolymeric polyesters. The products based on these copolymers, e.g. membranes or fabrics, are therefore more comfortable than the products based on homopolymeric polyesters.

Preferably, the polyester of the monolithic membrane has a VICAT temperature, measured in accordance with the method ASTM D 1525 (at 50° C./h, 10 N), in the range 140-200° C.

In one embodiment, the monolithic membrane may be a multilayer membrane, i.e. a membrane formed by an overlap of monolithic films having different chemical-physical characteristics. For example, the films of the individual layers that make up the polymeric monolithic membrane may have different levels of breathability, elasticity, etc. The film layers forming the monolithic membrane of the intermediate step 3 may be combined together, for example, by co-extrusion.

The number of layers forming a multilayer monolithic membrane is preferably in the range 2-4, more preferably in the range 2-3. In one embodiment, the multilayer membrane is formed by two layers.

Preferably, the monolithic membrane and the laminated composite material comprising it have a breathability in the range 40-15 m²Pa/W, more preferably in the range 10-30 m²Pa/W.

Preferably, the monolithic membrane has tensile strength (measured according to ASTM D882, machine direction—MD) in the range 20-40 MPa, more preferably in the range 25-35 MPa.

Preferably, the monolithic membrane has a value of elongation at break (measured according to ASTM D882, machine direction—MD) in the range 500-1,000%, more preferably in the range 600-900%.

Preferably, the monolithic membrane has tensile strength (measured according to ASTM D882, cross-machine direction—CD) in the range 20-40 MPa, more preferably in the range 25-35 MPa.

Preferably, the monolithic membrane has a value of elongation at break (measured according to ASTM D882, cross-machine direction) in the range 500-1,000%, more preferably in the range 600-900%.

The monolithic membranes usable for the purposes of the present invention can be prepared with the methods known to the person skilled in the art and are commercially available, produced for example by DuPont (Hytrel®) or by Exten S.A. (Switzerland).

The outer layers 9 and 11 comprise at least one polyester fabric. Such fabric is a woven fabric comprising or consisting of mutually woven polyester yarns or is a knitted fabric comprising or consisting of polyester yarns.

Preferably, the polyester yarns of the fabrics of the outer layers 9 and 11 have a count in the range 10-150 dTex, more preferably in the range 55-85 dTex.

In one embodiment, the polyester yarns of the fabrics, preferably orthogonal fabrics, of the outer layers 9 and 11 preferably have a count in the range 10-150 dTex, more preferably in the range 60-120 dTex, even more preferably in the range 70-100 dTex.

Preferably, the fabric comprises a number of warp threads/cm and a number of weft threads/cm, independently of each other, in the range 10-100, more preferably in the range 20-50.

Preferably, the knitted fabric comprises an areic mass (g/m²) in the range 10 g/m²-200 g/m², more preferably in the range 50 g/m²-100 g/m².

Advantageously, when the fabric comprises a number of warp threads/cm and a number of weft threads/cm in the aforesaid ranges, preferably in combination with a yarn count in the aforesaid ranges, it is substantially hydrophobic, thus rendering the surface treatment with water-repellent substances superfluous. This increases the recycling potentials of the composite material at the end of life and/or the obtainment of higher purity recycled polyester. In addition, the fabric, despite being hydrophobic, still has a certain capacity for absorbing liquids with the consequent advantage of preventing the unwanted “slipping” of the liquids on the clothings. In one embodiment, therefore, the fabric of the outer layers 9 and 11 is a fabric without fluid-repellent or water-repellent coating.

It has been observed that the liquid impermeability of the laminated composite material 1, tested for example by the test method ISO 16603:2004, is higher when at least one of the outer fabrics 9 or 11 has the following characteristics:
the number of warp threads/cm and the number of weft threads/cm, independently of each other, is in the range 10-100, more preferably in the range 20-50;
the count of warp and weft threads, independently of each other, is in the range 60-120 dTex, more preferably in the range 70-100 dTex. More preferably, said at least one outer fabric 9 or 11 is an orthogonal fabric.

In one embodiment, the fabric is a balanced fabric, i.e. having the same number of weft threads and warp threads per cm.

Preferably, the fabric has a weight in the range 20-100 g/m², more preferably in the range 40-80 g/m².

The fabric of polyester fibres may be for example a warp and weft fabric (orthogonal fabric) or a knitted fabric.

In a preferred embodiment, one of the outer layers 9, 11 comprises an orthogonal fabric and the remaining outer layer comprises instead a knitted fabric. The use of a knitted fabric for one of the outer layers allows clothings to be obtained that are more comfortable for the wearer, when these clothings are worn with the knitted fabric facing the wearer.

To favour reuse of the material following washing and/or sterilization, the laminated composite material according to the present invention does not comprise layers of non-woven fabric.

The polyester of the yarns of the outer fabrics 9, 11 can be chosen from a wide variety of polyester polymers known in the art. Non-limiting examples of such polymers are: polyethylene terephthalate, polybutylene terephthalate, polyethylene naphthalate, polybutylene naphthalate, polyethylene-1,2-bis(phenoxy)ethane-4,4′-dicarboxylate, poly(1,4 cyclohexylene-dimethylene terephthalate as well as the copolymers comprising at least one of the aforesaid repeating units or a combination thereof (e.g. polyethylene terephthalate/isophthalate co-polyester, polybutylene terephthalate/naphthalate co-polyester).

The polyester fabric may also comprise yarns other than polyester.

In one embodiment, the fabric comprising polyester used for the outer layer 9 and/or 11 is an antistatic fabric. The antistatic properties are advantageously imparted by incorporating an adequate amount of antistatic yarns into the fabric, for example using yarns of electrically conductive material (e.g. carbon yarns). The electrically conductive yarns can be woven together with the polyester fibres or yarns. Alternatively it is possible to make the antistatic fabric using a twisted yarn comprising a polyester yarn and an antistatic yarn.

Preferably, the fabric comprises polyester in an amount equal to or greater than 90% by weight with respect to the weight of the fabric, preferably equal to or greater than 95% by weight. In one embodiment, the fabric consists of 100% polyester by weight.

The intermediate layer 3 and the outer layers 9, 11 may also include additives and modifying agents of the type known in the art, such as colouring agents, plasticizers, fillers, antioxidants, stabilizers, etc.

Preferably the total amount of the aforesaid additives and modifying agents is equal to or less than 10% by weight with respect to the total weight of the laminated composite material, more preferably equal to or less than 5% by weight.

The outer layers 9, 11 and the intermediate layer 3 may be laminated together to form the laminated composite material of the invention using a variety of techniques known in the art. For example, the layers can be stably adhered to each other by ultrasonic welding, hot calendering, possibly with the aid of adhesive substances (glues), seams or a combination of the above techniques.

In a particularly preferred embodiment, the layers of the composite material are laminated together by ultrasonic welding. This technique offers in fact the advantage of not introducing additional materials (e.g. adhesive substances) into the composite material that might limit the recycling potentials of the latter at the end of its life cycle or the quality of the recycled material obtained.

In another preferred embodiment, the coupling of the layers to form the laminated composite material is made by gluing with a glue, more preferably a polyester-based glue of the type known in the art. The use of a polyester-based glue, while introducing additional material into the composite material, has the advantage of not limiting the recycling potentials of the latter since the additional material is also polyester-based.

The glue can be a hot-melt type glue, a UV-crosslinkable glue, a thermosetting glue or a water-based glue. Polyurethane-based hot-melt type glues usable for the purposes of the present invention are for example the glues JOWATHERM 630.80 and 673.08 marketed by JOWAT SE).

The glue can be applied on the surface of one or both layers 3, 9 and 11 to be adhered together. The glue may be applied continuously or, more preferably, discontinuously (dotted) in order to minimize the amount of glue used, while ensuring an adequate level of adhesion between the layers. Preferably, the total amount of glue applied is in the range 15-25 g/m².

The laminated composite material according to the present invention has a total areic mass in the range 100-200 g/m², preferably in the range 125-175 g/m².

The laminated composite material according to the present invention can be used in a wide variety of applications. In particular, the aforesaid composite material is suitable for manufacturing protective clothings for medical and surgical use that meet the requirements of standard UNI EN 13795:2019.

The composite material of the invention, in particular, meets one or more of the following requirements of standard UNI EN 13795:2019:
penetration of biologically contaminated dusts ≤1 Log CFU;
bacterial penetration in wet state (barrier index) Ib≥2,8;
degree of microbial cleanliness (stomaching method) ≤300 CFU/100 m²
longitudinal elongation in dry state ≥20 N
transverse elongation in dry state ≥20 N
longitudinal elongation in wet state ≥20 N
transverse elongation in wet state ≥20 N
bursting strength in dry state ≥40 kPa
bursting strength in wet state ≥40 kPa

The laminated composite material according to the present invention can be used in a wide variety of applications. In particular, the aforesaid composite material is suitable for manufacturing protective clothings for medical and surgical use that meet the requirements of standard UNI EN 14126:2004.

The composite material of the invention, in particular, after 50 cycles of f industrial washing (75° C.) and tumbler drying (80° C.), meets one or more of the following requirements of standard UNI EN 14126:2004:
Penetration of pathogens carried by blood and by other body fluids ≥20 KPa;
Bacterial penetration in wet state >75 minutes;
Penetration of contaminated biological liquid aerosols Log CFU>5;
Penetration of biologically contaminated dusts Log CFU<1;

The laminated composite material according to the present invention can be used in a wide variety of applications. In particular, the aforesaid composite material is suitable for manufacturing protective clothings for medical and surgical use that meet the requirements of standard UNI EN 14325:2005.

The composite material of the invention, in particular, meets after 50 cycles of industrial washing (75° C.) and of tumbler drying (80° C.) one or more of the following requirements of standard UNI EN 14325:2005:
Martindale abrasion>2000 cycles;
Resistance to bending damage>100,000 cycles;
Trapezoidal laceration>20 N;
Perforation>10 N;
Traction and elongation>250 N;
Liquid permeation:
   H₂SO₄ at 30%>10 minutes,
   10% NAOH>120 minutes.
      The composite material of the invention can be used, without particular limitations, to make articles, including for wearing, for preventing or reducing the of contamination by pathogens. Non-limiting risk examples of such articles are: surgical gowns and drapes (including the medical equipment covers), clean room clothings, overalls, aprons, footwear, hoods, caps, masks, gloves, gauze, plasters and the like.

In one embodiment, the aforesaid articles are made using the laminated composite material of the present invention as the sole, or substantially sole, textile material. The laminated composite material according to the invention, however, can also be used to make the aforesaid articles also in combination with additional materials.

The composite material of the invention and therefore the articles comprising it, in addition to being easily reusable following conventional washing (even hot one) and sterilization treatments, can be advantageously initiated to polyester recycling treatments at the end of its life cycle. For this purpose, substantially all the state-of-the-art treatment processes used to recycle polyester from plastic waste and scrap can be used (e.g. plastics deriving from the separate sorting of containers for food use in LDPE, HDPE, PP and PET).

The recycling process can be both of mechanical type and chemical type. In the mechanical recycling, for example, the product comprising the laminated composite material (e.g. a gown), after having been previously washed and/or sterilized, is generally reduced into fragments (e.g. by shredding or fraying processes) and subsequently densified. Densification can take place for example by extruding the fragments in an extruder with formation of recycled polyester granules. Where necessary, in the densification phase, different types of additives may be used to modify the chemical composition of the recycled polyester granules, e.g. chain extenders to increase the molecular weight, colouring agents to modify the colour, catalysts or other additives suitable for restoring the properties of the initial polymer and, in particular, to make it suitable for reuse as a secondary raw material for manufacturing polyester yarns.

In the chemical type recycling, the laminated composite material may instead be treated with the processes known to the person skilled in the art for the recovery of the polymer in the form of the starting monomers thereof or other useful hydrocarbon compounds. The usable chemical recovery processes are, for example, the processes based on depolymerization by glycolysis, methanolysis, hydrolysis or ammonolysis.

The following example is provided purely for the purpose of illustration of the present invention and should not be regarded as a limitation of the scope of protection defined by the appended claims.

### EXAMPLE 1

A laminated composite material according to the present invention has been prepared having a warp and weft polyester fabric (outer layer), a monolithic polyester membrane (intermediate layer) and a polyester knitted fabric (inner layer).

For the outer layer use was made of the fabric “Antistatic Rosy”, marketed by INTEX Spa (Italy); for the inner layer use was made of the knitted fabric “395AX” marketed by the company Maglificio Ripa Spa (Italy); the monolithic membrane is the product “S999 30 μm” marketed by the company Exten S.A.

The fabric “Antistatic Rosy” was made up of 98% by weight of polyester yarns and 2% by weight of carbon yarns (warp and weft count equal to 84 dTex; 44 threads/cm of warp; 28 threads/cm of weft; areic mass of 60 g/m²).

The knitted fabric “395AX” is made up of polyester yarns (areic mass of 55 g/m²).

The monolithic membrane “S999 30 μm” is a membrane of a polyester-polyether block copolymer (containing crystalline segments of polybutylene terephthalate (PBT) and amorphous segments formed by polyether glycol chains) having the following characteristics: tensile strength comprised between 31.2 MPa (LSL) and 46.8 MPa (USL) MD; 28 MPa (LSL) and 42 MPa (USL) CD. Elongation at break comprised between 680% (LSL) and 1020% (USL) MD; 736% (LSL) and 1104% (ULS) CD. Strength to 25% elongation comprised between 7.2 MPa (LSL) and 10.8 MPa (ULS) MD; 6.8 Mpa (LSL) and 10.2 MPa (ULS) CD.

The three layers were laminated together by ultrasonic welding.

The laminated composite material had a total weight of 142 g/m². On the laminated composite material, the tests of compliance with the requirements established in standard UNI EN 13795-1:2019 reported in Table 1 have been carried out.

TABLE 1

| | | REFERENCE | |
|---|---|---|---|
| TEST | RESULT | VALUE | TEST METHOD |
| Penetration of biologically | 10 CFU | <300 CFU | UNI EN ISO |
| contaminated dusts | | | 22612: 2005 + |
| | | | EC1-2011 + UNI EN |
| | | | 13795-112019 |
| Bacterial | 5.5-5.6 | ≥2.8 | UNI EN ISO |
| penetration in wet | | | 2261032006 + UNI EN |
| state (I_{B}) | | | 13795-1 Z2019 |
| Microbial cleaning | 3.4E+001 | ≥300 CFU/100 cm² | UNI EN ISO 11737- |
| (stomaching method) | CFU/100 cm² | | 1:2018 + UNI EN |
| | | | 13795-1:2019 |
| Bursting strength in | 2123 KPa | ≥40 KPa | UNI EN ISO 13938- |
| dry state | | | 1:2001 + EC 1:2004 + |
| | | | UNI EN 13795-1:2019 |
| Bursting strength in | 1893 KPa | ≥40 KPa | UNI EN ISO 13938- |
| wet state | | | 1:2001 + EC 1:2004 + |
| | | | UNI EN 13795-1:2019 |
| Tensile strength in | 1254.2 N | ≥20 N | UNI EN 29073- |
| dry state | (longitudinal | | 311993 + UNI EN |
| | direction) | | 13795-1:2019 |
| | 817 N (transverse | ≥20 N | |
| | direction) | | |
| Tensile strength in | 1232.8 N | ≥20 N | UNI EN 29073- |
| wet state | (longitudinal | | 311993 + UNI EN |
| | direction); | | 13795-1:2019 |
| | 796 N (transverse | ≥20 | |
| | direction) | | |
| Evaporative | 21.1 m²Pa/W | 21.1 m²Pa/W | UNI EN ISO |
| resistance to water | | | 11092:2014 |
| vapour “Rₑₜ” | | | |
| Protective | 50 Cycles | / | UNI EN ISO |
| clothings. | | | 15797:2018 Tab.4 |
| Industrial washing | | | Procedure A |
| and drying | | | (tumbler finish) + |
| | | | UNI EN ISO |
| | | | 13688:2013 Par 5.2 |
| Protective | Dimensional | / | UNI EN ISO |
| clothings. | variations in | | 15797:2018 Tab. 4 |
| Dimensional | length | | Procedure A |
| variations with | −3% | | (tumbler finish) + |
| industrial washing. | Dimensional | | UNI EN ISO |
| | variations in | | 3759:2011 +UNI EN |
| | width | | ISO 5077:2008 + |
| | −1.5% | | UNI EN ISO |
| | | | 13688:2013 Par 5.3 |

The results in Table 1 confirm the suitability of the laminated composite material according to the invention for making protective clothings for medical and surgical use. Similar results were obtained using a laminated composite material in which the three layers were coupled by means of a polyurethane-based hot-melt glue (JOWATHERM 630.80).

### EXAMPLE 2

The laminated composite material according to example 1, after being subjected to 50 washing cycles (UNI EN ISO 15797:2018 Tab.4 Procedure A (tumbler finish)), was subjected to the test “Penetration of blood and body fluids. Synthetic blood method” according to test method ISO 16603:2004 (procedure D). The material passed the test, as the sample tested turned out to be resistant to the penetration of synthetic blood at all the hydrostatic pressure values envisaged by the method.

1. A laminated composite material comprising:
an intermediate layer comprising a polymeric monolithic membrane comprising a polyester, said intermediate layer having a first and a second face;
a first outer layer comprising a polyester fabric, said first outer layer having a first inner surface adhering to said first face of said intermediate layer;
a second outer layer comprising a polyester fabric, said second outer layer having a second inner surface adhering to said second face of said intermediate layer.

2. The laminated composite material according to claim 1, wherein said first or second outer layer is chosen from orthogonal fabric and knitted fabric.

3. The laminated composite material according to claim 1, wherein said first outer layer is an orthogonal fabric and said second outer layer is a knitted fabric.

4. The laminated composite material according to claim 1, wherein said polyester of said polymeric monolithic membrane is chosen from: ether-ester block copolymer, imide-ester block copolymer, ether-imide-ester block copolymer and mixtures thereof.

5. The laminated composite material according to claim 1, wherein said fabric of said first or second outer layer comprises polyester fibres in an amount equal to or greater than 90% by weight with respect to the weight of the fabric.

6. The laminated composite material according to claim 1, wherein said first or second outer layer is joined to said intermediate layer by means of a glue, a polyester-based glue, or by ultrasonic heat welding.

7. The laminated composite material according to claim 1, wherein said fabric of said first or second outer layer is an antistatic fabric.

8. The laminated composite material according to claim 1, wherein at least one of said first or second outer layer is an orthogonal fabric of yarns having a count in the range 10-150 dTex.

9. The laminated composite material according to claim 1, wherein at least one of said first or second outer layer is an orthogonal fabric in which the number of warp threads/cm and the number of weft threads/cm, independently of each other, is in the range 10-100.

10. An article for preventing or reducing the risk of contamination by pathogens comprising a laminated composite material according to claim 1.

11. A protective clothing comprising a laminated composite material according to claim 1.

12. The protective clothing according to claim 11 chosen from: gown, overall, apron, footwear, hood, cap, mask, glove, gauze and plaster.

13. A method for manufacturing a laminated composite material according to claim 1 comprising the steps of:
a. providing:
(i). an intermediate layer comprising a polymeric monolithic membrane comprising a polyester, said intermediate layer having a first and a second face;
(ii) a first outer layer comprising a polyester fabric, said first outer layer having a first inner surface;
(iii). a second outer layer comprising a polyester fabric, said second outer layer having a second inner surface;
b. adhering said first and second inner surfaces of said first and second outer layers respectively to said first and second faces of said intermediate layer to form said laminated composite material.

14. The method according to claim 13, wherein said adhesion step b comprises joining said first and second outer layers to said intermediate layer by means of a glue, a polyester-based glue, or by ultrasonic welding.
